(19) United States
(12) Patent Application Publication
(10) Pub. No.: US 2007/0218324 A1
(43) Pub. Date: Sep. 20, 2007

(54) FUEL CELL VOLTAGE STABILIZATION APPARATUS

(76) Inventors: CHUN-CHIN TUNG, Chupei (TW); YUNG-LIEH CHIEN, Chupei (TW)

Correspondence Address: G. LINK CO., LTD., 3550 BELL ROAD, MINOOKA, IL, 60447, US

(21) Appl. No.: 11/670,313

(22) Filed: Feb. 1, 2007

(30) Foreign Application Priority Data
Mar. 14, 2006 (TW) 095204142

(51) Int. Cl. H01M 8/00; H01M 8/04; G05F 1/00

(52) U.S. Cl. 429/13; 323/222; 429/22

(57) ABSTRACT

A fuel cell voltage stabilization apparatus is disclosed. The apparatus utilizes electronic circuits for voltage modulation to stabilize and fix the voltage load for a fuel cell. The apparatus comprises a voltage boost circuit and a voltage reducing circuit, which are realized by electronic circuits to stabilize an output voltage of the fuel cell and fix the output voltage to the loading.

### FIELD OF THE INVENTION

The present invention relates to a fuel cell voltage stabilization apparatus, utilizing electronic circuits for voltage modulation to stabilize and fix the voltage load for a fuel cell.

### BACKGROUND OF THE INVENTION

Conventionally, a fuel cell works in such a way that an output voltage of the fuel cell is larger when the loading terminal has a lower load, and the output voltage is smaller when the loading terminal has a higher load. In order to obtain a large or small stable voltage, a stabilization apparatus for a power source with accurate control of its voltage is required. For example, when a cell phone device is utilized as the loading terminal, the stabilization apparatus has to reduce the output voltage of a battery cell from 3.6V to 3.3V, which is required for the logic and I/O elements, or to 1.8V or 1.2V, which are generally required for the processor cores. In other examples, the stabilization apparatus has to raise the output voltage to 4.5V for backlights, to 5V for USB interface devices, to 9V for CCD camera modules, or to a high voltage of 4 KV for xenon flash tube devices.

Furthermore, the output voltage of the fuel cell is variable in relation to the loading terminal, so the stabilization apparatus can not be realized by a single voltage raising or reducing circuit to fix the voltage of the loading.

In consideration of the above-mentioned problems, a voltage stabilization apparatus capable of raising and reducing the output voltage of the fuel cell and stabilizing the voltage is in great need.

### SUMMARY OF THE INVENTION

Accordingly, an objective of the invention is to provide a fuel cell voltage stabilization apparatus, utilizing a voltage boost circuit (BOOST) and a low dropout voltage linear regulator (LDO) in a parallel connection, and the voltage boost circuit comprises a switching device configured to switch the voltage boost circuit alternatively between an ON status and an OFF status.

To achieve the above-mentioned objective, the fuel cell voltage stabilization apparatus may comprise the voltage boost circuit and a voltage reducing circuit, and the voltage reducing circuit may comprise a low dropout voltage linear regulator (LDO). The low dropout voltage linear regulator may comprise an electronic switch to switch the LDO alternatively between the ON status and the OFF status. When the loading terminal has a lower load, the output voltage of the fuel cell is larger than the voltage of the loading, so the LDO would transform and reduce the output voltage to the required voltage of the loading, and the switching device would cut off the voltage boost circuit. When the loading terminal has a higher load, the output voltage is smaller than the voltage of the loading, so the LDO would be turned off, and the voltage boost circuit would transform and raise the output voltage to the required voltage of the loading.

The invention discloses a fuel cell voltage stabilization apparatus, utilizing electronic circuits for voltage modulation to stabilize and fix the voltage load for a fuel cell. The apparatus comprises a voltage boost circuit (BOOST) and a low dropout voltage linear regulator (LDO) and is placed between a fuel cell and a loading terminal. When a high voltage is needed, a fuel cell stack can be provided to raise the voltage. However, the fuel cell stack would increase the cost and reduce the reliability of the fuel cells. Furthermore, for the voltage requirement of the power source of general electronic devices (such as 3.3V), the output voltage of the fuel cell does not easily meet the requirement. This is due to variation of the output voltage of the fuel cell in relation to the loading terminal. As a result, a stabilization apparatus to stabilize the voltage is in need. A basic voltage boost transformer is generally formed by a metal oxide semiconductor field effect transistor (MOSFET) switch element, a conductance, a diode and a capacitor. By switching of the MOSFET switch element and the diode, a voltage boost can be achieved. The relation between the input voltage and the output voltage can be shown in the following formula:

Vout/Vin=1/(1−D)

wherein:
Vout refers to the output voltage;
Vin refers to the input voltage; and
D refers to the operation period, D<=1.

As a result, the output voltage would be larger than the input voltage.

Furthermore, to output a low voltage, the low dropout voltage linear regulator (LDO) can be utilized to reduce the voltage. The LDO is suited to parallel connection with the voltage boost circuit and works in a system in which the output voltage of the fuel cell is variable in relation to the loading terminal. Furthermore, the LDO has the advantages of low PCB occupying area, low price and low power consumption. The LDO is a voltage drop type DC/DC transformer.

By parallel connecting both circuits between the fuel cell and the loading terminal, the voltage boost circuit and the low dropout voltage linear regulator (LDO) can be regulated such that the output voltage equals the required voltage of the loading terminal. A preferable operative condition is that the voltage of the loading terminal is larger than the output voltage of most of the fuel cell.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an illustrative view of an embodiment of a fuel cell voltage stabilization apparatus of the invention; and

FIG. 2 is an illustrative view of an embodiment of the voltage boost circuit.

### DETAILED DESCRIPTION OF THE INVENTION

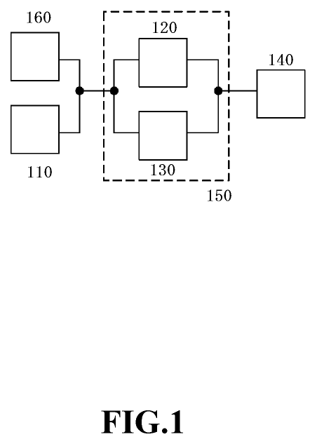

FIG. 1 is an illustrative view of an embodiment of a fuel cell voltage stabilization apparatus of the invention. The fuel cell 110 is connected to the voltage stabilization apparatus 150, and the voltage stabilization apparatus 150 stabilizes and provides the power generated by the fuel cell 110 in a predetermined voltage to a loading terminal 140.

The fuel cell 110 can be a power generating device utilizing hydrogen-rich fuels and oxygen-rich fuels to perform chemical response and generate electricity. For example, in an embodiment of a direct methyl alcohol fuel cell, the fuel cell 110 utilizes methyl alcohol and oxygen to perform chemical response and generate electricity. The voltage stabilization apparatus 150 comprises a voltage boost device to raise the output voltage of the fuel cell 110 and a voltage reducing device to reduce the output voltage of the fuel cell 110, and switches between the voltage boost device and the voltage reducing device to regulate the output voltage of the fuel cell 110 according to the voltage requirement of the loading terminal 140. The voltage boost device and the voltage reducing device can be achieved by a voltage boost circuit 120 and a low dropout voltage linear regulator (LDO) 130. The voltage boost circuit 120 and the voltage reduce circuit 130 are connected in parallel. The loading terminal 140 is an electronic device that consumes the electricity output by the fuel cell 110.

The voltage boost circuit 120 can be achieved by electronic circuits, and an embodiment thereof will be described in detail. The voltage boost circuit 120 comprises a switching device configured to switch the voltage boost circuit 120 alternatively between an ON status and an OFF status. The switching device may be achieved by an active diode element, a metal oxide semiconductor field effect transistor (MOSFET) switch element, or any other switching elements. The low dropout voltage linear regulator (LDO) 130 can be also achieved by electronic circuits. When the loading terminal 140 has a higher voltage requirement than the output voltage, the switching device of the voltage boost circuit 120 would turn on the voltage boost circuit 120, and the electricity power output from the fuel cell 110 would be transformed by the voltage boost circuit 120 to raise the output voltage to the required voltage of the loading terminal 140. When the loading terminal 140 has a lower voltage requirement than the output voltage, the switching device of the voltage boost circuit 120 would cut off the voltage boost circuit 120, and the electricity power output from the fuel cell 110 would be transformed by the LDO 130 to reduce the output voltage to the required voltage of the loading terminal 140.

The LDO 130 compares the voltage to a reference voltage by the voltage dividing circuits to control the LDO 130 to turn on or turn off, and to output a stable voltage to the loading terminal 140.

The fuel cell voltage stabilization apparatus may further comprise a rechargeable battery cell 160 to provide power source of the loading terminal 140 in a predetermined output voltage in correspondence with the fuel cell 110.

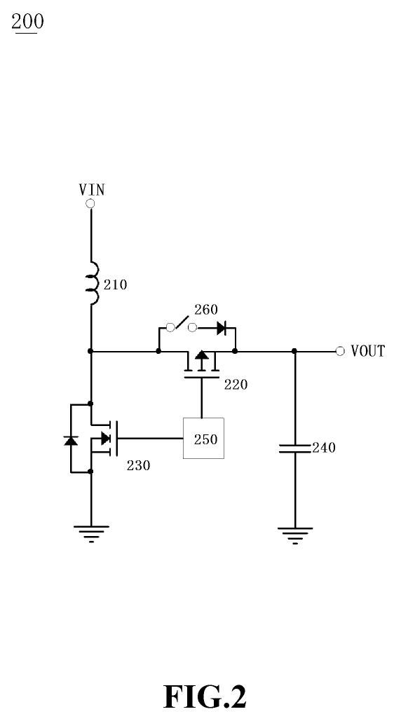

FIG. 2 illustrates an embodiment of the voltage boost circuit. The voltage boost circuit 200 comprises a conductance 210, a first switch element 220, a second switch element 230, a capacitor 240, a controller 250, and an active diode 260. The first switch element 220 can be an active diode or other switch elements. The second switch element 230 can be a metal oxide semiconductor field effect transistor (MOSFET) switch element or other switch elements. The controller 250 can be utilized to switch alternatively the first switch element 220, the second switch element 230 and the active diode 260 in the ON status or the OFF status. Specifically, the first switch element 220 is switched alternatively to the second switch element 230 and concurrently with the active diode 260 according to a relation between the output voltage and the input voltage of the voltage stabilization apparatus. The relation is shown as:

Vout/Vin=1/(1−D)

wherein:
Vout refers to the output voltage;
Vin refers to the input voltage; and
D refers to the operation period, D<=1.

With the controller 250, the second switch element 230 controls an operative period of the voltage boost circuit 200, and the first switch element 220 controls the voltage boost circuit 200 to cut off input and output when the voltage boost circuit 200 is inoperative. As a result, the output voltage of the voltage stabilization apparatus responds, transforming and raising the output voltage of the fuel cell, thus achieving the voltage boost.

According to the above-mentioned embodiment, when the voltage requirement of the loading is smaller than the output voltage, the controller 250 cuts off the first switching element 220 and the second switching element 230, and further turns off the active diode 260, and the electricity power output from the fuel cell would be transformed by the LDO to reduce the output voltage to the required voltage of the loading terminal. On the other hand, when the voltage requirement of the loading is larger, the output voltage the fuel cell would be lower than the voltage required, and the LDO would be turned off and the voltage boost circuit would be turned on, and the electricity power output from the fuel cell would be transformed by the voltage boost circuit to raise the output voltage to the required voltage of the loading terminal.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell voltage stabilization apparatus, comprising:
a fuel cell configured to provide power source of a loading terminal;
a voltage boost circuit configured to raise an output voltage of the fuel cell; and
a voltage reducing circuit configured to reduce the output voltage of the fuel cell;
wherein the voltage boost circuit comprises a switching device configured to switch the voltage boost circuit alternatively between an ON status and an OFF status.

2. The fuel cell voltage stabilization apparatus as claimed in claim 1, wherein the switching device of the voltage boost circuit further comprises:
a first switch element configured to control the voltage boost circuit to cut off input and output when the voltage boost circuit is inoperative;
a second switch element configured to control an operative period of the voltage boost circuit; and
a controller;
wherein the voltage boost circuit is switched alternatively by the first switch element and the second switch element to obtain the output voltage larger than an input voltage.

3. The fuel cell voltage stabilization apparatus as claimed in claim 2, wherein the first switch element comprises an active diode element.

4. The fuel cell voltage stabilization apparatus as claimed in claim 2, wherein the second switch element comprises a metal oxide semiconductor field effect transistor (MOSFET) switch element.

5. The fuel cell voltage stabilization apparatus as claimed in claim 1, wherein the voltage reducing circuit is a low dropout voltage linear regulator.

6. The fuel cell voltage stabilization apparatus as claimed in claim 1, wherein the fuel cell is a direct methyl alcohol fuel cell.

7. The fuel cell voltage stabilization apparatus as claimed in claim 1, wherein the fuel cell further comprises a rechargeable battery cell to provide power source of the loading terminal in a predetermined output voltage in correspondence with the fuel cell.

8. The fuel cell voltage stabilization apparatus as claimed in claim 7, wherein the rechargeable battery cell is selected from a lithium battery cell and other power source device to provide power source of the loading terminal.
